(19) United States
(12) Patent Application Publication
(10) Pub. No.: US 2006/0078777 A1
(43) Pub. Date: Apr. 13, 2006

(54) Fuel cell housing

(76) Inventors: Mark W. Grimes, Spokane, WA (US); Scott A. Spink, Spokane, WA (US)

Correspondence Address: WELLS ST. JOHN P.S., 601 W. FIRST AVENUE, SUITE 1300, SPOKANE, WA, 99201, US

(21) Appl. No.: 10/964,847

(22) Filed: Oct. 13, 2004

(51) Int. Cl. H01M 2/02; H01M 8/06; A47F 7/00

(52) U.S. Cl. 429/34; 429/19; 211/49.1

(57) ABSTRACT

A housing for enclosing a fuel cell is shown and which is mounted on an adjacent enclosure having at least one substantially vertically disposed surface, and wherein the housing positions the fuel cell in spaced relation relative to an underlying supporting surface.

### TECHNICAL FIELD

The present invention relates to a fuel cell housing, and more specifically to a housing for enclosing a fuel cell and which may be readily mounted to an adjacent enclosure.

### BACKGROUND OF THE INVENTION

The operation of fuel cells are well known. Several different designs of fuel cells have emerged, in recent years, and which have increasing levels of reliability and usefulness in industries such as the telecommunications, and in the uninterruptible power supply markets (UPS). Among the most promising fuel cell designs which have emerged in recent years are fully disclosed in U.S. Pat. Nos. 6,030,718 and 6,468,682, the teachings of which are incorporated by reference herein. In each of the patents, noted above, a modular fuel cell has been disclosed, and which includes a number of discreet fuel cell modules which are substantially self-humidifying, and which offer a degree of reliability, ease of maintenance and other advantages not known heretofore when compared with prior art fuel cell stacks. These particular modular fuel cells have become quite useful inasmuch as individual modules may be removed from the fuel cell for repair or replacement while the remaining fuel cells continue in operation to supply electricity to a load. As the usefulness of these fuel cells has become recognized, their applications in industry segments such as the UPS market has increased. In market segments, such as telecommunications, interest in fuel cells has continued to grow inasmuch as the current state of the art for uninterruptible power supplies includes the use of multiple rechargeable batteries. These UPS systems are designed to maintain critical telecommunications circuits in an operational condition when AC power is lost. The UPS market has long recognized that batteries are quite inefficient in certain environmental applications. It is well known, for example, that deep cycling of batteries prematurely shortens the lifetime of the batteries. Moreover, the amount of power that may be delivered from batteries decreases as the ambient environmental temperature falls. Moreover, batteries present an increased maintenance problem as the batteries increase in age.

In addition to the shortcomings noted above, telecommunications equipment that is in need of UPS equipment, frequently are enclosed within cabinets which must meet extremely stringent certification requirements as imposed by the telecommunications industry. These cabinets are often housed or placed in small rooms or spaces where the amount of available floor space for placing other assemblies in cabinets such as might enclose a fuel cell, for example, is either at a minimum or not available at all. Placing a fuel cell, for example, within an existing telecommunications cabinet or enclosure does not appear to be a viable alternative inasmuch as the existing cabinet would need to be altered, by cutting a number of required air vents in the cabinet, to allow the air required for cooling, and the reaction in the fuel cell, to enter the cabinet. These alterations of an existing telecommunications enclosure will typically cause cabinets, such as these, to be decertified. This is generally considered unacceptable to most telecommunications customers.

Therefore, the present invention is directed to a fuel cell housing which addresses these and other issues attendant with the use of a fuel cell.

### SUMMARY OF THE INVENTION

A first aspect of the present invention relates to a housing for enclosing a fuel cell and which is mounted on an adjacent enclosure having at least one substantially vertically disposed surface, and wherein the housing positions the fuel cell in spaced relation relative to an underlying supporting surface.

Another aspect of the present invention relates to a housing for enclosing a fuel cell and which includes a top surface; a bottom surface; and at least one sidewall mounted on the top and bottom surfaces, and which defines a cavity for receiving the fuel cell, and wherein the housing is mounted on an adjacent enclosure which contains electrical equipment, and which receives electrical power from the fuel cell, and wherein the enclosure rests on an underlying supporting surface and the housing positions the fuel cell in spaced relation relative to the underlying supporting surface.

Still another aspect of the present invention relates to a housing for enclosing a fuel cell, and which includes a top surface having a peripheral edge which is closely adjacent to a supporting surface of an adjacent enclosure, and wherein the adjacent enclosure rests on an underlying supporting surface; a sidewall mounted on the top surface and depending downwardly therefrom, and which further is disposed in spaced relation relative to the supporting surface of the adjacent enclosure; a bottom surface having a peripheral edge which is closely adjacent to the supporting surface of the adjacent enclosure, and wherein the sidewall, and top and bottom surfaces define a cavity which receives a fuel cell, and wherein the housing positions the fuel cell in spaced relation relative to the underlying supporting surface, and wherein the fuel cell, when operational, produces electrical power which is delivered to the enclosure; a source of fuel for the fuel cell, and which is positioned in the enclosure, and which is coupled in fluid flowing relation relative to the fuel cell; and an air movement assembly borne by the housing, and which is coupled in fluid flowing relation relative to the enclosure, and with the fuel cell, and wherein the air movement assembly is operable to selectively withdraw and/or deliver air, in an air stream, to the enclosure, and the fuel cell.

Still another aspect of the present invention relates to a housing for enclosing a fuel cell having a plurality of removable modules, on an adjacent enclosure, and which includes a top surface having a peripheral edge which is mounted thereagainst an exterior sidewall of the adjacent structure; a plurality of sidewalls, each of which is mounted on the top surface, and which depends downwardly therefrom; a bottom surface having a peripheral edge which is mounted thereagainst the sidewall of the adjacent enclosure, and which is further mounted to the respective sidewalls which depend downwardly relative to the top surface, and wherein the top and bottom surfaces, and the plurality of sidewalls define an internal cavity, and wherein the fuel cell having the plurality of removable modules is received in the internal cavity, and wherein the adjacent enclosure rests on a supporting surface, and wherein the bottom surface is disposed in spaced relation relative to the supporting surface; an air movement assembly received in the housing and which is operable to selectively withdraw air from the enclosure, and deliver the withdrawn air, in an air stream to the fuel cell, and wherein the fuel cell, in operation, generates heat energy, and wherein the air stream moves into contact with the fuel cell and removes, at least in part, the heat energy generated by the fuel cell, and wherein the resulting heated air stream is selectively delivered by the air movement assembly back to the enclosure; an electrical conduit extending from the enclosure into the internal cavity of the housing, and wherein the fuel cell, when operational, produces electricity which is supplied to the electrical conduit; and a fuel conduit extending from the enclosure into the internal cavity of the housing, and wherein the fuel conduit delivers a source of fuel to the fuel cell.

These and other aspects of the present invention will become more readily apparent hereinafter.

### BRIEF DESCRIPTION OF THE DRAWINGS

Preferred embodiments of the invention are described below with reference to the following accompanying drawings.

FIG. 1 is a perspective side elevational view of a prior art electrical equipment cabinet.

FIG. 2 is a side elevation view of a second form of a prior art electrical equipment cabinet.

FIG. 3 is a side elevation view of the present invention, and which is shown mounted on the door of a prior art electrical cabinet as seen in FIG. 2.

FIG. 4 is a side elevation view of the present invention, and which is shown mounted on a sidewall of a prior art electrical cabinet as seen in FIG. 2.

FIG. 5 is a greatly simplified depiction of a fuel cell module.

FIG. 6 is a perspective view of a fuel cell module.

FIG. 7 is a greatly simplified perspective side elevation view of the present invention, and with some underlying surfaces shown in phantom lines.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

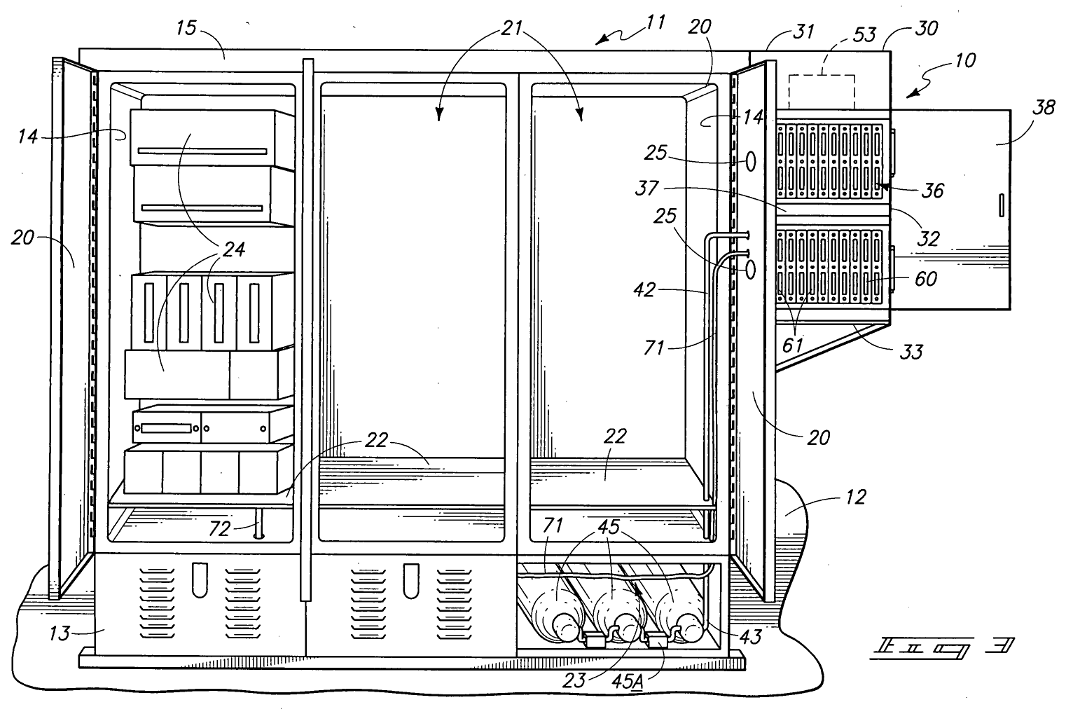

The housing for enclosing a fuel cell of the present invention is generally indicated by the numeral 10 in FIGS. 3-5.

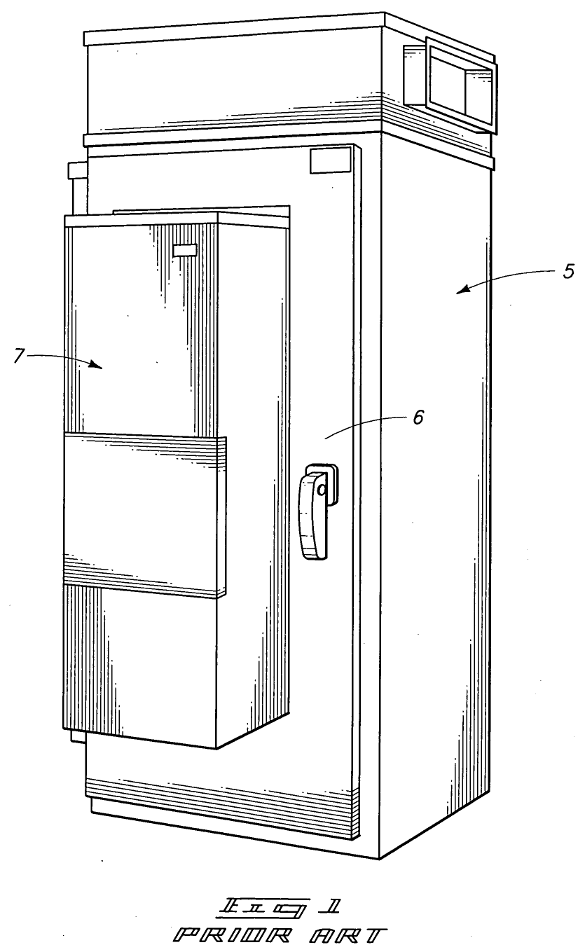

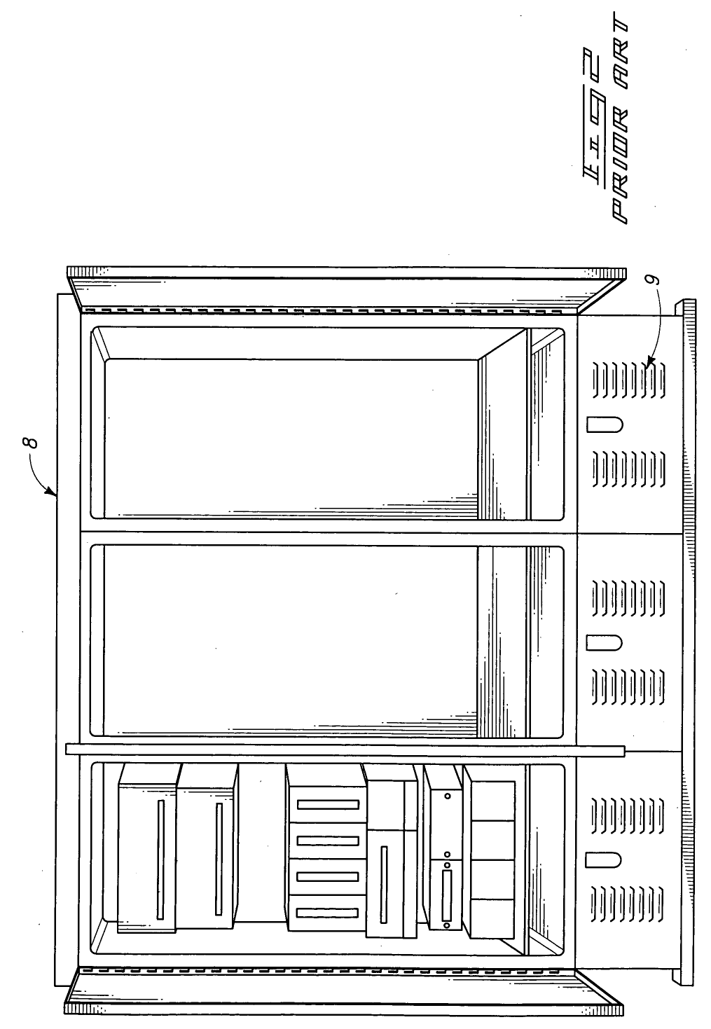

Referring now to FIGS. 1 and 2, two different prior art telecommunication cabinets are shown. In FIG. 1, a prior art cabinet 5 is shown and which has a door 6 which allows access to the cabinet 5. In the arrangement of FIG. 1, an air conditioning unit 7 is mounted or otherwise made integral with the door 6, and which provides cooling air to maintain the temperature inside of the cabinet 5 within a given temperature range.

Referring now to FIG. 2, a prior art telecommunications cabinet 8 is shown, and which encloses various pieces of electronic equipment. The cabinet has a lower storage area 9 which typically encloses a plurality of prior art batteries (not shown), and which comprise, in part, an uninterruptible power supply of the electronic equipment.

Referring now to FIGS. 3-5, the housing 10 of the present invention is mounted on an adjacent and modified enclosure or cabinet 11, such as might be used with telecommunications equipment and the like. The enclosure 11 rests on a supporting surface 12 such as the surface of the earth, or other supporting surface 12. The enclosure 11 has a base portion 13 which is typically affixed by a suitable fastener (not shown) to the supporting surface. Extending generally upwardly relative to the base portion 13, are a plurality of nonhorizontally disposed sidewalls generally indicated by the numeral 14. These nonhorizontally or substantially vertically disposed sidewalls 14 are joined together at their distal ends by a top surface which is generally indicated by the numeral 15. An access door 20 is provided and which allows a user to gain access to an upper cavity 21, and which is defined by the plurality of nonhorizontally disposed sidewalls 14. Still further, a plurality of shelves 22 are positioned internally of the cavity and are mounted to the respective nonhorizontally disposed sidewalls 14 to provide internal supporting surfaces. Still further, the base portion 13 defines, in part, a lower cavity 23. The various shelves 22 support electronic equipment which is generally indicated by the numeral 24. This electronic equipment, when energized, typically produces heat energy which heats the air that is contained within the enclosure 11. As seen in FIG. 3, a plurality of apertures 25 are formed in at least one of the nonhorizontally disposed sidewalls, or the access door 20.

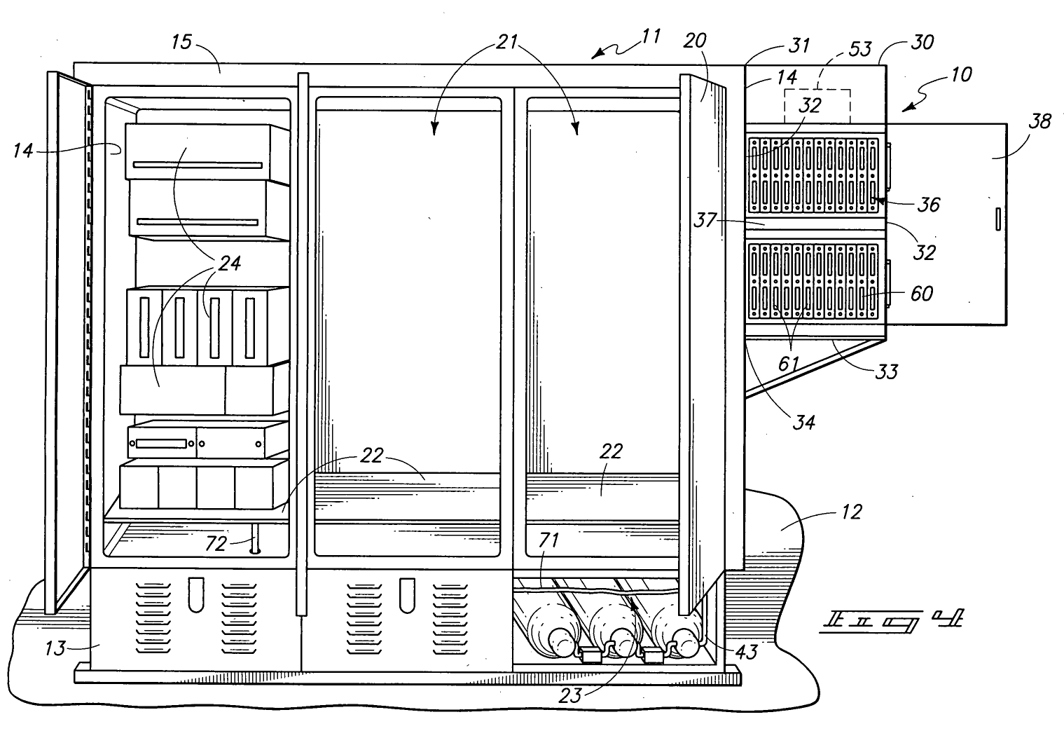

Referring now to FIGS. 3 and 4, it will be recognized that the housing 10 of the present invention can be mounted on either one of the nonhorizontally disposed sidewalls 14 of the adjacent enclosure 11 (FIG. 4), or on the access door 20 (FIG. 3), depending upon the available space requirements within the room or space where the enclosure 11 is located. In this regard, the housing 10 is defined by a top surface 30 which has a peripheral edge 31, and which is mounted adjacent to either of the nonhorizontally disposed sidewalls 14, or the access door 20. The top surface may be disposed in a number of different orientations relative to the underlying supporting surface 12. Therefore, while the present drawings show the top surface in a substantially horizontal and spaced relationship relative to the supporting surface 12, it will be recognized that the top surface may be disposed in various angular orientations relative thereto. The housing 10 has a plurality of depending sidewalls 32 which are mounted to, and depend downwardly from the top surface 30. Still further, the housing has a bottom surface 33 which has a peripheral edge 34, and which is mounted adjacent to the nonhorizontally disposed sidewalls 14, or the access door 20 depending upon the installation preference. The housing 10 defines an internal cavity 36. Still further, a supporting shelf 37 may be received in the internal cavity 36, and which is mounted to the respective depending sidewalls 32, in order to provide a supporting surface which receives and supports the fuel cell, and other components which will be discussed below. An access door 38 is provided and which is mounted on the housing 10 and which can be opened and closed to provide convenient access to the internal cavity 36.

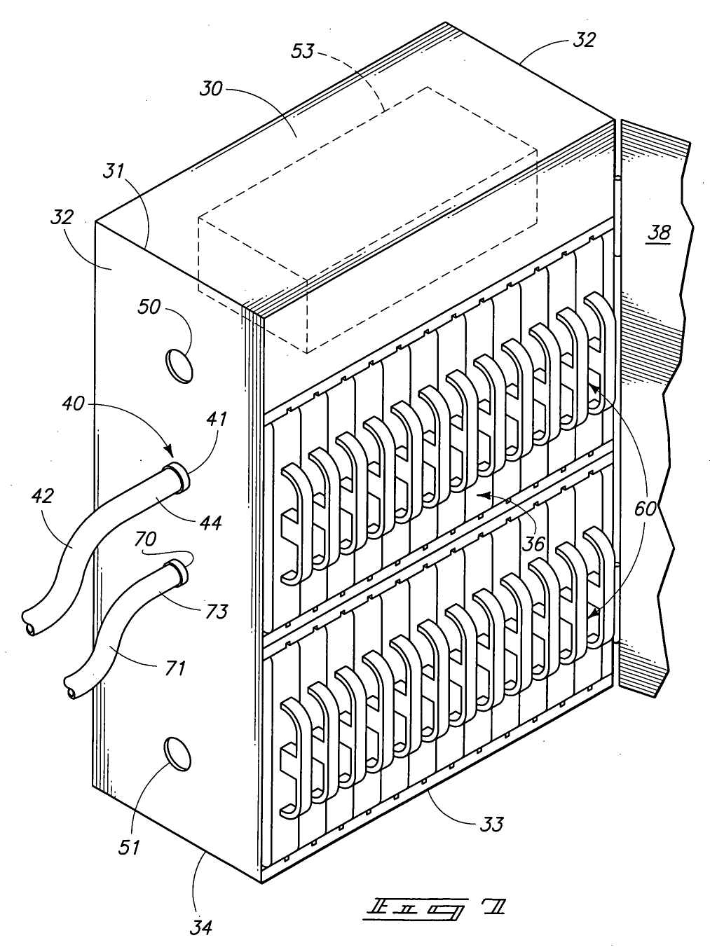

As seen in FIG. 7, a plurality of apertures 40 are formed in the housing 10 and which are substantially coaxially aligned with the several apertures 25 which are formed in one of the nonhorizontally disposed sidewalls 14, or the access door 20 (FIG. 3). These respective of apertures include, among others, a fuel conduit aperture 41. A fuel conduit 42 is provided and which has a first end 43 which is received within the second or lower cavity 23 of the adjacent enclosure 11; and an opposite second end 44 which is positioned with the cavity 36 as defined by the housing 10. The first end 43 of the fuel conduit 42 is coupled in fluid flowing relation relative to a source of fuel 45 which is received within the second or lower cavity 23. This source of fuel is typically contained within a number of tanks. In an alternative embodiment, not shown, a reformer, which comprises a source of fuel, may be installed within the lower cavity and which is operable to receive a hydrocarbon source, such as natural gas, or the like, and react same with a suitable catalyst in order to release a stream of hydrogen. This hydrogen is then consumed by the fuel cells, which will be discussed below. The source of fuel may further include a manifold 45A which couples the several tanks together in fluid flowing relation to provide the source of fuel to the first end 43, of the fuel conduit 42. The fuel that is provided from the fuel source 45 typically includes hydrogen which is supplied to the fuel cell which will be discussed, below. The fuel conduit 42, which extends through the coaxially aligned apertures, is typically sealed, thereabout, with a suitable gasket or seal thereby maintaining the integrity, and the certification of the adjacent enclosure 11. As further seen in FIG. 7, apertures 50 and 51 are provided in one of the sidewalls 32, and which are substantially coaxially aligned with individual apertures 25 which are formed in the nonhorizontally disposed sidewall 14 or access door 20. The aperture 50 defines an air inlet, and the aperture 51 defines an air outlet. The air inlet and air outlet are each coupled in fluid flowing relation relative to an air movement assembly 53. The air movement assembly is positioned within the internal cavity 36 as defined by the housing 10. The air movement assembly, which is borne by the housing 10, delivers a flow of air to the fuel cell 60 which is described below. As a general matter, however, the air movement assembly is operable to selectively withdraw air from the adjacent enclosure 11, and deliver the withdrawn air in an air stream to the fuel cell 60. As should be understood, the fuel cell, 60 in operation generates heat energy, and the air stream moves into contact with the fuel cell, and removes, at least in part, the heat generated by the fuel cell. The resulting heated air stream is then selectively delivered by the air movement assembly 53 back to the enclosure by way of the air outlet 51. The air inlet and outlet 50 and 51, are connected to the air movement assembly 53 and the fuel cell 60 by suitable air flow conduits, (not shown).

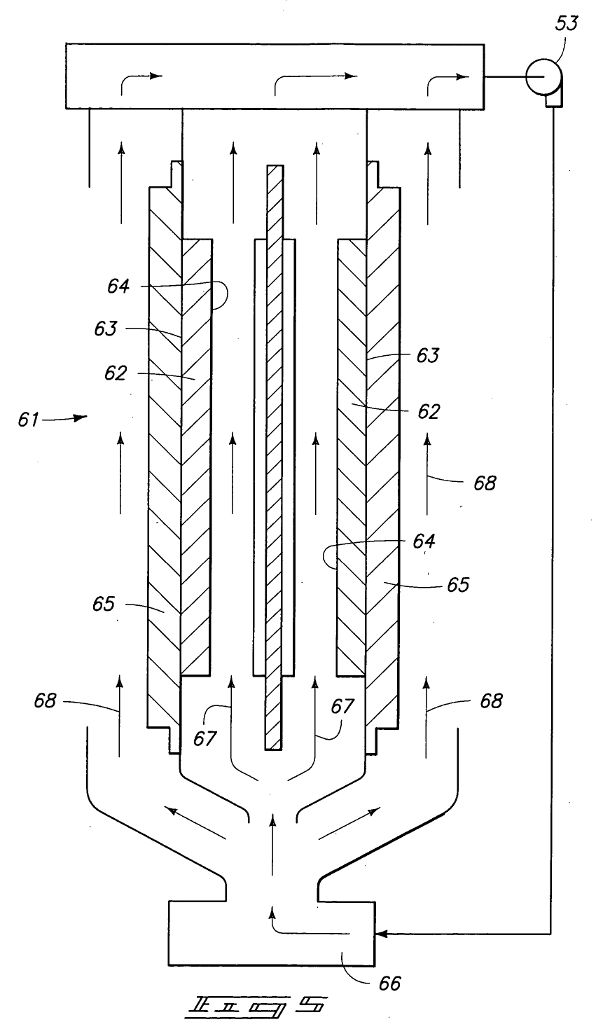

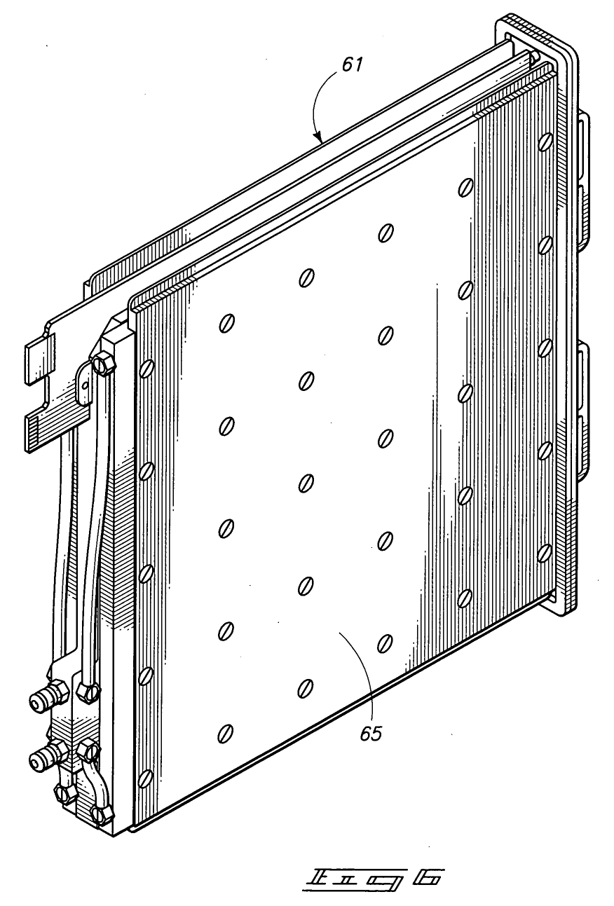

Referring now to FIGS. 3, 4 and 6, a fuel cell 60, which is described in more detail in U.S. Pat. No. 6,468,682, the teachings of which are incorporated by reference herein, is shown. Referring now to FIG. 5 which illustrates a greatly simplified view of a typical fuel cell module 61, it will be recognized that the fuel cell 60 includes multiple modules 61, each enclosing a membrane electrode diffusion assembly 62 (FIG. 5) which has an anode 63 and a cathode 64. The fuel cell 60, when energized, produces electricity and heat energy as a by-product. As seen in FIGS. 5 and 6, the modules 61 each includes a heat sink 65, which is disposed in heat removing relation relative to one of the anode and/or cathodes of at least one of the fuel cell modules 61. As was discussed above, at least one of the modules 61 can be removed from the fuel cell 60, by hand while the remaining modules continue to operate. The air movement assembly 53 which is borne by the housing 10 (FIGS. 5 and 7) delivers a flow of air which has been previously withdrawn from the internal cavity 36, and provides a resulting air stream 66 to the fuel cell 60. As seen in FIG. 5, the air stream 66 includes a first air stream 67, which is delivered to the cathode 64 of each of the membrane electrode diffusion assemblies 62, and a second air stream 68, which passes over the heat sink 65. The first and second air streams are operable to remove, at least in part, the heat energy generated by the fuel cell 60. In the arrangement as shown, and depending upon the arrangement of the air inlets and outlets 50 and 51, as described above, the first and second air streams 67 and 68 may be exhausted, at least periodically, to the ambient environment, and through the air outlet, 51. In the arrangement, as shown in the drawings, however, the first and second air streams 67 and 68, having once passed through the fuel cell 60, becomes heated. These heated air streams 67 and 68 are then delivered to the internal cavity 21 by way of the air outlet 51.

As should be understood, the electrical equipment 24, when energized, generates heat energy, which in turn, heats the air within the cavity 21 of the enclosure 11. Further, the air movement assembly 53 is operable to withdraw this heated air through the air inlet 50, and deliver this same heated, withdrawn air, from the enclosure 11, to the fuel cell 60 so as to heat the fuel cell when the ambient environmental temperatures are low. Conversely, and as noted above, the fuel cell generates heat energy during operation, and this heat energy is operable to heat the first and second air streams 67 and 68. In the arrangement as shown, the air movement assembly 53 is operable to deliver these respective heated air streams, at least periodically into the enclosure 11 so as to heat, at least in part, the electrical equipment 24 contained within the enclosure 11 during periods of low ambient temperature. In the arrangement as shown, the air movement assembly 53 is rendered operable to withdraw air, alternatively, from the enclosure 11, or from the ambient environment, and further is operable to deliver air which has passed through, or by the fuel cell 60, back to the enclosure 11, or alternatively back to the ambient environment or combinations of the above.

As best seen by reference to FIG. 7, an aperture 70 is formed in one of the depending sidewalls 32, of the housing 10, and further is coaxially aligned with one of the plurality of apertures 25 which are individually formed in the nonhorizontally disposed sidewall 14, or access door 20 of the enclosure 11. The aperture 70 is operable to receive an electrical conduit 71 therethrough. The electrical conduit has a first end 72 which is positioned within the enclosure 11, and is electrically coupled to the respective pieces of electrical equipment 24, and an opposite distal or second end 73 (FIG. 7) which is electrically coupled to the fuel cell 60. In this fashion, the fuel cell is operable to deliver electrical power generated directly to the electrical equipment in the event of failure of the AC power which normally powers that same equipment.

### Operation

The operation of the described embodiment of the present invention is believed to readily apparent and is briefly summarized at this point.

In its broadest aspect, the present invention relates to a housing 10 for enclosing a fuel cell 60, and which is mounted on an adjacent enclosure 11 having at least one substantially vertically disposed surface 14. The housing 10 positions the fuel cell 60 in spaced relation to an underlying supporting surface 12.

Another aspect of the present invention relates to a housing 10 for enclosing a fuel cell 60, and which includes a top surface 30, a bottom surface 33, and at least one sidewall 32, mounted on the top and bottom surfaces, and which defines a cavity 36 for receiving the fuel cell 60. The housing 10 is mounted on an adjacent enclosure 11, and which contains electrical equipment 24, and which receives electrical power from the fuel cell 60. The enclosure 11 sits on an underlying supporting surface 12, and the housing 10 positions the fuel cell 60 in spaced relation relative to the underlying supporting surface 12.

Yet another aspect of the present invention relates to a housing 10 for enclosing a fuel cell 60, and which includes a top surface 30 having a peripheral edge 31, and which is closely adjacent to a supporting surface 12 of an adjacent enclosure 11. The adjacent enclosure 11 rests on an underlying supporting surface 12. A sidewall 32 is mounted on the top surface 30, and depends downwardly therefrom, and which further is disposed in spaced relation relative to the supporting surface 12 of the adjacent enclosure 11. A bottom surface 33 is provided, and which has a peripheral edge 34, and which is closely adjacent to the sidewall 14 of the adjacent enclosure 11. The sidewall 32, and top and bottom surfaces 30 and 33 define a cavity 36 which receives a fuel cell 60. The housing 10 positions the fuel cell in spaced relation relative to the underlying supporting surface 12. The fuel cell 60, when operational, produces electrical power which is delivered to the enclosure 11. A source of fuel 45 for the fuel cell 60, is provided, and which is positioned in the enclosure 11, and which is coupled in fluid flowing relation relative to the fuel cell 60. Still further, an air movement assembly 53 is provided and which is coupled in fluid flowing relation relative to the enclosure 11, and with the fuel cell 60. The air movement assembly is operable to selectively withdraw and/or deliver air, in an air stream 66, to the enclosure, and the fuel cell 60, respectively.

Yet still another aspect of the present invention relates to a housing 10 for enclosing a fuel cell 60 having a plurality of removable modules 61, on an adjacent enclosure 11, and which includes, a top surface 30, having a peripheral edge 31, and which is mounted thereagainst an exterior sidewall 14 of the adjacent structure 11. The housing further has a plurality of sidewalls 32, each of which is mounted on the top surface 30, and which depends downwardly therefrom. Still further, the housing 10 includes a bottom surface 33 which is mounted thereagainst the sidewall 14 of the adjacent enclosure 11. This bottom surface is further mounted to the respective sidewalls 32, and which depend downwardly relative to the top surface 30. The top and bottom surfaces 30 and 33, and the plurality of sidewalls 32 define the internal cavity 36. The fuel cell 60 includes a plurality of removable modules 61 which are received in the internal cavity 36. The bottom surface 33 of the housing is disposed in spaced relation relative to the supporting surface 12. An air movement assembly 53 is provided, and which is received in the housing 10, and which is operable to selectively withdraw air from the enclosure 11, and deliver the withdrawn air, in an air stream 66 to the fuel cell. The fuel cell 60, in operation, generates heat energy. As presently arranged, the air stream 66 moves into contact with the fuel cell and removes, at least in part, the heat energy generated by the fuel cell. The resulting heated air stream is then selectively delivered by the air movement assembly 53 back into the enclosure 11. An electrical conduit 71 is provided and which extends from the enclosure 11, into the internal cavity 36 of the housing 10. The fuel cell 60, when operational, produces electricity which is supplied to the electrical conduit 71 and which powers the individual pieces of the electronic equipment 24 which are enclosed within the enclosure 11. A fuel conduit 42 is provided and which extends from the enclosure 11 and into the internal cavity 36 of the housing 10. The fuel conduit 42 delivers a source of fuel 45 to the fuel cell 60.

As seen in the drawings, the present housing 10 can be mounted on a fixed sidewall 14, or on an access door 20 of an existing enclosure 11 thereby preserving precious floor space in otherwise cramped rooms or spaces where these enclosures 11 are typically placed.

Therefore it will be seen that the housing 10 of the present invention provides many advantages over the prior art practices and allows a fuel cell such as seen the prior art patents referenced in this application to be utilized as an effective UPS system for telecommunications and other critical electronic equipment.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. A housing for enclosing a fuel cell and which is mounted on an adjacent enclosure having at least one substantially vertically disposed surface, and wherein the housing positions the fuel cell in spaced relation relative to an underlying supporting surface.

2. A housing as claimed in claim 1, and wherein the adjacent enclosure rests on the underlying supporting surface and further encloses electrical equipment, and wherein the fuel cell is electrically coupled with the electrical equipment and which, when energized, produces electrical power which is supplied to the electrical equipment.

3. A housing as claimed in claim 2, and wherein the housing defines a cavity which receives the fuel cell, and wherein the fuel cell has multiple modules, and wherein at least one of the modules can be easily removed from the fuel cell, and the cavity of the housing, by hand, while the remaining fuel cell modules continue to operate.

4. A housing as claimed in claim 2, and wherein the housing defines a cavity which receives the fuel cell, and wherein the housing further includes a door which permits access to the cavity, and the fuel cell.

5. A housing as claimed in claim 2, and wherein fuel cell is electrically coupled to the electrical equipment enclosed within the enclosure by way of an electrical conduit which sealably passes through the substantially vertically disposed surface of the enclosure.

6. A housing as claimed in claim 5, and wherein the substantially vertically disposed surface is a sidewall of the enclosure.

7. A housing as claimed in claim 5, and wherein the substantially vertically disposed surface is a door which is moveably mounted on the enclosure.

8. A housing as claimed in claim 1, and wherein the housing permits the flow of air to, and from the fuel cell, while simultaneously impeding ambient weather conditions from substantially adversely effecting the operation of the fuel cell.

9. A housing as claimed in claim 1, and wherein the enclosure defines a cavity which receives the electrical equipment, and wherein the fuel cell has an air inlet and air outlet, and wherein the air inlet of the fuel cell is disposed in fluid flowing relation relative to the cavity of the enclosure, and the air outlet communicates with the ambient environment, and wherein air is withdrawn from the cavity of the enclosure and into the fuel cell.

10. A housing as claimed in claim 1, and wherein the enclosure defines a cavity which receives the electrical equipment, and wherein the fuel cell has an air inlet, and an air outlet, and wherein the air inlet and outlet are each coupled in fluid flowing relation relative to the cavity of the enclosure, and wherein the fuel cell withdraws air for use in the fuel cell from the cavity of the enclosure, and through the air inlet, and exhausts air which has previously passed through the fuel cell back to the cavity of the enclosure through the air outlet.

11. A housing for enclosing a fuel cell, comprising:
a top surface;
a bottom surface; and
at least one sidewall mounted on the top and bottom surfaces, and which defines a cavity for receiving the fuel cell, and wherein the housing is mounted on an adjacent enclosure which contains electrical equipment, and which receives electrical power from the fuel cell, and wherein the enclosure rests on an underlying supporting surface and the housing positions the fuel cell in spaced relation relative to the underlying supporting surface.

12. A housing as claimed in claim 11, and wherein the enclosure has at least one nonhorizontally disposed sidewall, and a moveable door which permits access to the electrical equipment contained in the enclosure, and wherein the enclosure defines a first cavity which receives the electrical equipment, and a second cavity.

13. A housing as claimed in claim 12, and wherein the housing is mounted on the moveable door and/or the nonhorizontally disposed sidewall.

14. A housing as claimed in claim 12, and further comprising:
a source of fuel which is consumed by the fuel cell during operation, and which is received in the second cavity of the enclosure; and
a fuel conduit coupling the source of fuel in fluid flowing relation relative to the fuel cell, and wherein the fuel conduit extends from the second cavity of the enclosure, and into the housing.

15. A housing as claimed in claim 14, and wherein the source of fuel comprises a tank of compressed gas.

16. A housing as claimed in claim 14, and wherein the source of fuel comprises a chemical reformer.

17. A housing as claimed in claim 11, and wherein the fuel cell has multiple modules, each enclosing a membrane electrode diffusion assembly which has an anode and cathode, and wherein the fuel cell, when energized, produces electricity and heat energy as a byproduct, and wherein at least one of the fuel cell modules has a heat sink which is disposed in heat removing relation relative to one of the anode and/or cathodes of at least one of the fuel cell modules, and wherein at least one of the modules can be removed from the housing, and the fuel cell, by hand, while the remaining modules continue to operate.

18. A housing as claimed in claim 17, and further comprising:
an air movement assembly borne by the housing and which delivers a flow of air to the fuel cell, and wherein the flow of air is bifurcated to provide a first air stream which is delivered to the cathode of each of the membrane electrode diffusion assemblies, and a second air stream which passes over the heat sink and is operable to remove, at least in part, the heat energy generated by the fuel cell.

19. A housing as claimed in claim 18, and wherein fuel cell further comprises:
an air inlet, and an air outlet, and wherein the air inlet and outlet are each disposed in fluid flowing relation relative to the ambient environment, and wherein the air movement assembly withdraws air from the ambient environment and through the air inlet, and exhausts at least a portion of the air through the air outlet, and which has been previously delivered to the fuel cell.

20. A housing as claimed in claim 19, and wherein both the first and second air streams are exhausted, at least periodically, to the ambient environment, and through the air outlet.

21. A housing as claimed in claim 19, and wherein the first air stream is exhausted, at least periodically, to the ambient environment, and through the air outlet, and wherein the second air stream is delivered, at least periodically, into the enclosure so as to heat, at least in part, the electrical equipment contained in the enclosure.

22. A housing as claimed in claim 18, and further comprising:
an air inlet, and an air outlet, and wherein the air inlet and outlet are each coupled in fluid flowing relation relative to the enclosure and/or the ambient environment, and wherein the air movement assembly selectively withdraws air from the enclosure and/or ambient environment, and through the air inlet, and selectively exhausts at least a portion of the air through the air outlet, and which had been previously delivered to the fuel cell.

23. A housing as claimed in claim 22, and wherein the second air stream which has been previously delivered to the fuel cell is periodically exhausted by the air outlet to the enclosure to heat the electrical equipment, and the first air stream which has been previously delivered to the fuel cell is periodically exhausted by the air outlet to the ambient environment.

24. A housing as claimed in claim 22, and wherein the electrical equipment contained within the enclosure, when energized, produces heat energy, and wherein the air movement assembly withdraws air through the air inlet, and from the enclosure, and delivers the withdrawn air, from the enclosure, to the fuel cell, so as to heat the fuel cell.

25. A housing for enclosing a fuel cell, comprising:
a top surface having a peripheral edge which is closely adjacent to a supporting surface of an adjacent enclosure, and wherein the adjacent enclosure rests on an underlying supporting surface;
a sidewall mounted on the top surface and depending downwardly therefrom, and which further is disposed in spaced relation relative to the supporting surface of the adjacent enclosure;
a bottom surface having a peripheral edge which is closely adjacent to the supporting surface of the adjacent enclosure, and wherein the sidewall, and top and bottom surfaces define a cavity which receives a fuel cell, and wherein the housing positions the fuel cell in spaced relation relative to the underlying supporting surface, and wherein the fuel cell, when operational, produces electrical power which is delivered to the enclosure;
a source of fuel for the fuel cell, and which is positioned in the enclosure, and which is coupled in fluid flowing relation relative to the fuel cell; and
an air movement assembly borne by the housing and which is coupled in fluid flowing relation relative to the enclosure, and with the fuel cell, and wherein the air movement assembly is operable to selectively withdraw and/or deliver air, in an air stream, to the enclosure, and the fuel cell.

26. A housing as claimed in claim 25, and wherein the fuel cell, when operational, produces electricity, and heat as a byproduct, and wherein the air movement assembly removes at least a portion of the heat generated by the fuel cell, by way of the air stream which is delivered to the fuel cell, and wherein the air stream which has removed the heat generated by the fuel cell is delivered to the enclosure to heat the enclosure.

27. A housing as claimed in claim 25, and wherein the enclosure contains at least one piece of electrical equipment which is selectively energized by the electrical power which is generated by the fuel cell, and wherein the at least one piece of electrical equipment generates heat energy when energized, and wherein air present in the enclosure is heated by the heat energy generated by the at least one piece of electrical equipment, and wherein the air movement assembly withdraws the heated air within the enclosure and delivers the heated air from the enclosure to the fuel cell, to heat the fuel cell.

28. A housing for enclosing a fuel cell having a plurality of removable modules, on an adjacent enclosure, comprising:
a top surface having a peripheral edge which is mounted thereagainst an exterior sidewall of the adjacent structure;
a plurality of sidewalls, each of which is mounted on the top surface, and which depends downwardly therefrom;
a bottom surface having a peripheral edge which is mounted thereagainst the sidewall of the adjacent enclosure, and which is further mounted to the respective sidewalls which depend downwardly relative to the top surface, and wherein the top and bottom surfaces, and the plurality of sidewalls define an internal cavity, and wherein the fuel cell having the plurality of removable modules is received in the internal cavity, and wherein the adjacent enclosure rests on a supporting surface, and wherein the bottom surface is disposed in spaced relation relative to the supporting surface;
an air movement assembly received in the housing and which is operable to selectively withdraw air from the enclosure, and deliver the withdrawn air, in an air stream to the fuel cell, and wherein the fuel cell, in operation, generates heat energy, and wherein the air stream moves into contact with the fuel cell and removes, at least in part, the heat energy generated by the fuel cell, and wherein the resulting heated air stream is selectively delivered by the air movement assembly back to the enclosure;
an electrical conduit extending from the enclosure into the internal cavity of the housing, and wherein the fuel cell, when operational, produces electricity which is supplied to the electrical conduit; and
a fuel conduit extending from the enclosure into the internal cavity of the housing, and wherein the fuel conduit delivers a source of fuel to the fuel cell.

29. A housing as claimed in claim 28, and wherein the plurality of sidewalls includes at least one door.

30. A housing as claimed in claim 28, and wherein the exterior sidewall of the enclosure comprises a door.

31. A housing as claimed in claim 28, and wherein the source of fuel for use by the fuel cell is positioned in the adjacent enclosure, and is coupled in fluid flowing relation relative to the fuel conduit.

32. A housing as claimed in claim 31, and wherein the source of fuel comprises a tank of a gas which is consumed by the fuel cell.

33. A housing as claimed in claim 31, and wherein the source of fuel comprises a chemical reformer.
